(19) United States
(12) Patent Application Publication
(10) Pub. No.: US 2022/0357431 A1
(43) Pub. Date: Nov. 10, 2022

(54) DETECTION AND RANGING SYSTEMS EMPLOYING OPTICAL WAVEGUIDES

(71) Applicant: Lumus Ltd., Ness Ziona (IL)

(72) Inventor: Yochay DANZIGER, Kfar Vradim (IL)

(21) Appl. No.: 17/764,634

(22) PCT Filed: Dec. 21, 2020
(86) PCT No.: PCT/IL2020/051315

§ 371 Date: Mar. 29, 2022

Related U.S. Application Data
(60) Provisional application No. 62/954,739, filed on Dec. 30, 2019.

(51) Int. Cl. G01S 7/481; G02B 6/42; G01S 17/89

(52) U.S. Cl. CPC G01S 7/4818; G02B 6/42; G02B 6/4206; G02B 6/4214; G01S 17/89; G01S 13/931

(57) ABSTRACT

An optical waveguide has at least two major external surfaces and is configured for guiding light by internal reflection, and is deployed with one of the two major external surfaces in facing relation to a scene. An optical coupling-out configuration is associated with the optical waveguide and is configured for coupling a proportion of light, guided by the optical waveguide, out of the optical waveguide toward the scene. An illumination arrangement is deployed to emit light for coupling into the optical waveguide that is collimated prior to being coupled in the optical waveguide. A detector is configured for sensing light reflected from an object located in the scene in response to illumination of the object by light coupled out of the optical waveguide by the optical coupling-out configuration. A processing subsystem is configured to process signals from the detector to derive information associated with the object.

### CROSS-REFERENCE TO RELATED APPLICATIONS

This application claims priority from U.S. Provisional Patent Application No. 62/954,739, filed Dec. 30, 2019, whose disclosure is incorporated by reference in its entirety herein.

### TECHNICAL FIELD

The present invention relates to optical waveguides, and in particular it concerns optical waveguides used in detection and ranging systems.

### BACKGROUND OF THE INVENTION

Light detection and ranging (LIDAR) systems are used in a variety of applications, including, for example, in three-dimensional (3D) sensors for autonomous vehicles. LIDAR systems employ a light-emitter unit for transmitting laser pulses, a scanning-type arrangement that directs the emitted laser pulses toward a scene so as to scan a large field of interest, and a light-receiver unit that collects light reflected from objects in the scene and processes the collected reflected light to derive information about the scanned objects.

The light-emitter unit typically transmits the laser pulses at relatively high intensity that can be harmful to the human eye. Therefore, many LIDAR systems require adherence to eye-safety regulations, in particular in situations in which the LIDAR system is deployed in a vehicle, such as an autonomous vehicle. The intensity of the laser light is determined by several parameters, including, for example, the transmission power of the laser light source, the duration of the laser pulse, the angular divergence of the laser beam, and the size of the exit pupil at the output of the light-emitter unit. In order to achieve a longer operational range, it is preferable to transmit laser light with relatively short pulse duration at relative high intensity and low beam divergence.

In order to achieve high intensity for each spot of the illuminated scene, the beam is scanned across the scene (typically vertically and horizontally (i.e., laterally) by the scanning arrangement) so as to transmit pulses of light in various directions. The scanning arrangement can he implemented in various ways, but is usually implemented using a relatively large fast-moving mirror that provides scanning in both vertical and horizontal directions for the laser transmitter aperture.

Optimal or near optimal results can be achieved using light-emitters and light-receivers that operate in the near infrared (NIR) region of the electromagnetic spectrum. However, light in the NIR region is not visible to the human eye, and therefore MR light can cause substantial damage to an observer's eye without the observer being aware that damage is being caused. In order to reduce the likelihood of damaging the human eye, many LIDAR systems operating in the NIR range employ power-limiting at the emitter to reduce the intensity of the received reflected beams.

### SUMMARY OF THE INVENTION

The present invention is a detection and ranging system employing an optical waveguide. In preferred embodiments, beams from multiple laser light sources, operating at different wavelengths (preferably in the MR region), are combined as a combined beam to illuminate a scanning arrangement (es., scanning mirror). The scanned beam is collimated by collimating optical components such as collimating lenses or reflecting mirrors, and is coupled into an optical waveguide that is constructed from a transparent material (such as glass). The light is coupled into the optical waveguide by an optical coupling-in configuration, typically implemented as a coupling prism or a coupling-in reflector. The coupled-in light is trapped within the optical waveguide between major external surfaces of the waveguide by internal reflection so as to be guided through (i.e., propagate within) the waveguide. The propagating light is gradually coupled out of the waveguide by an optical coupling-out configuration, preferably implemented as a set of mutually parallel partially reflective surfaces deployed within the waveguide oblique to parallel major surfaces of the waveguide. As a result, the input beam to the waveguide is multiplied into several parallel output beams thereby multiplying the output aperture of the system while maintaining parallel propagation. The output beam is composed of all of the constituent laser beams, which co-propagate. In certain embodiments, the scanning arrangement scans the transmitted field while maintaining a large output aperture so as to achieve a large scanned output field. In certain preferred but non-limiting embodiments, one of the laser light sources operates at a wavelength in the visible region of the electromagnetic spectrum for improved eye safety.

According to the teachings of an embodiment of the present invention, there is provided a system. The system comprises: an optical waveguide having at least two major external surfaces for guiding light by internal reflection, a first of the two major external surfaces deployed in facing relation to a scene; an optical coupling-out configuration associated with the optical waveguide configured for coupling a proportion of light, guided by the optical waveguide, out of the optical waveguide toward the scene; an illumination arrangement deployed to emit light for coupling into the optical waveguide that is collimated prior to being coupled in the optical waveguide; a detector for sensing light reflected from an object located in the scene in response to illumination of the object by light coupled out of the optical waveguide by the optical coupling-out configuration; and a processing subsystem including at least one processor, the processing subsystem being electrically associated with the detector and configured to process signals from the detector to derive information associated with the object.

Optionally, the system further comprises: focusing optics for focusing the reflected light onto the detector.

Optionally, the focusing optics is associated with a second of the two major external surfaces.

Optionally, the reflected light is transmitted by the two major external surfaces before being received by the focusing optics.

Optionally, an output aperture of the system is defined at least in part by the coupling-out configuration, and an input aperture of the system is defined at least in part by the focusing optics.

Optionally, the input aperture is at least partially overlapping with the output aperture.

Optionally, the input aperture and the output aperture are non-overlapping.

Optionally, the system further comprises: a diffractive optical element associated with the first of the two major external surfaces.

Optionally, the system further comprises: a scanning arrangement deployed to scan the scene with light coupled out of the optical waveguide by the optical coupling-out configuration.

Optionally, the scanning arrangement is deployed between the illumination arrangement and the optical waveguide, and the scanning arrangement is configured to deflect light emitted by the illumination arrangement to cover an angular range such that the light coupled out of the optical waveguide covers a corresponding angular range.

Optionally, the scanning arrangement is associated with the first of the two major external surfaces.

Optionally, the system further comprises: collimating optics deployed in an optical path between the illumination arrangement and the optical waveguide for collimating light emitted by the illumination arrangement prior to coupling into the optical waveguide.

Optionally, the system further comprises: an optical component deployed in an optical path between the illumination arrangement and the optical waveguide and configured to perform aperture expansion of light emitted by the illumination arrangement in at least a first dimension.

Optionally, the system further comprises: a scanning arrangement associated with the first of the two major external surfaces and configured to scan a second dimension orthogonal to the first dimension.

Optionally, the optical component is configured to perform expansion of light emitted by the illumination arrangement in the first dimension and in a second dimension orthogonal to the first dimension.

Optionally, the optical component includes: a light-transmitting substrate for guiding light emitted by the illumination arrangement by internal reflection, and a second optical coupling-out configuration associated with the substrate for coupling a proportion of light, guided by the substrate, out of the substrate toward the optical waveguide.

Optionally, the optical coupling-out configuration includes a plurality of partially reflective surfaces deployed within the optical waveguide obliquely to the two major external surfaces.

Optionally, the optical coupling-out configuration includes a diffractive optical element associated with at least one of the two major external surfaces.

Optionally, the system further comprises: an optical coupling-in configuration associated with the optical waveguide and configured for coupling light into the optical waveguide so as to propagate within the optical waveguide by internal reflection.

Optionally, the illumination arrangement includes a plurality of beam sources, the beam sources configured to produce light at different respective wavelengths.

Optionally, the illumination arrangement further includes a beam combiner for combining the light produced by the beam sources into a combined light beam.

Optionally, the wavelengths are in the near infrared region of the electromagnetic spectrum.

Optionally, the beam sources are implemented as laser sources.

Optionally, the laser sources are pulsed laser sources, and the processing subsystem is electrically associated with the illumination arrangement and is further configured to control pulse timing of the laser sources.

Optionally, one of the beam sources is configured to produce light in the visible region of the electromagnetic spectrum, and the remaining beam sources are configured to produce light at different respective wavelengths in the near infrared region of the electromagnetic spectrum.

Optionally, the processing subsystem is electrically associated with the illumination arrangement and is further configured to control illumination timing of the illumination arrangement.

Optionally, the information associated with the object derived by the processing subsystem includes time of flight information.

Optionally, the information associated with the object derived by the processing subsystem includes distance from the detector to the object.

Optionally, the processing subsystem is further configured to construct a three-dimensional representation of the object based on the information associated with the object.

Optionally, the system is deployed in a ground-based vehicle.

Optionally, the system is mounted to an aircraft.

Optionally, the optical waveguide has a trapezoidal-shape in a cross-sectional plane so as to effect lateral scanning of the scene with light coupled out of the optical waveguide.

Optionally, the system further comprises: a light-transmitting substrate having two pairs of parallel major external surfaces forming a rectangular cross-section; and an optical coupling configuration associated with the substrate, and light that is coupled into the substrate advances by four-fold internal reflection through the substrate and a proportion of intensity of the light advancing through the substrate is coupled out of the substrate by the optical coupling configuration and into the optical waveguide.

Optionally, the optical waveguide includes two pairs of parallel major external surfaces forming a rectangular cross-section, and light that is coupled into the optical waveguide advances by four-fold internal reflection through the optical waveguide.

Optionally, the system further comprises: an optical coupling configuration, and the optical waveguide includes a first waveguide section associated with the optical coupling configuration and a second optical waveguide section associated with the optical coupling-out configuration, and light that is coupled into the optical waveguide advances through the first waveguide section by internal reflection and a proportion of intensity of the light advancing through the first waveguide section is deflected in a first direction by the optical coupling configuration so as to be coupled out of the first waveguide section and into the second waveguide section so as to advance through the second waveguide section by internal reflection, and light advancing through the second waveguide section is deflected in a second direction by the optical coupling-out configuration so as to be coupled out of the optical waveguide toward the scene.

Optionally, the optical coupling configuration effectuates scanning of light in a first dimension, and the optical coupling-out configuration effectuates scanning of light in a second dimension substantially orthogonal to the first dimension.

There is also provided according to an embodiment of the teachings of the present invention a light detection and ranging (VIDAR) system. The LIDAR system comprises: a transmitter comprising: an optical waveguide having at least two major external surfaces for guiding light by internal reflection, one of the major external surfaces deployed in facing relation to a scene, an optical coupling-out configuration associated with the optical waveguide configured for coupling a proportion of light, guided by the optical waveguide, out of the optical waveguide toward the scene, at least one beam source configured to emit a coherent beam of light for coupling into the optical waveguide that is collimated prior to being coupled in the optical waveguide, and a scanning arrangement deployed to scan the scene with light coupled out of the optical waveguide by the optical coupling-out configuration; a receiver comprising: a detector for sensing light reflected from an object located in the scene in response to illumination of the object by light coupled out of the optical waveguide by the optical coupling-out configuration; and a processing subsystem including at least one processor, the processing subsystem being electrically associated with the detector and configured to process signals from the detector to construct a three-dimensional representation of the object.

Optionally, the processing subsystem is electrically associated with the illumination arrangement and is further configured to control illumination timing of the illumination arrangement.

Optionally, the transmitter has an output aperture defined at least in part by the optical coupling-out configuration, and the receiver has an input aperture defined at least in part by the focusing optics, and the input aperture is at least partially overlapping with the output aperture.

Optionally, the transmitter has an output aperture defined at least in part by the optical coupling-out configuration, and the receiver has an input aperture defined at least in part by the focusing optics, and the input aperture and the output aperture are non-overlapping.

The term “optical waveguide” as used herein in the description and claims refers to any light-transmitting body, preferably light-transmitting solid bodies, formed from transparent material, which are referred to interchangeably herein as “light-transmitting substrates”, “light-guides” or “light-guide optical elements”.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a schematic representation of a light detection and ranging (LIDAR) system having a transmitter, receiver, and processing system, deployed in a vehicle for illuminating an object located in a scene, according to a non-limiting embodiment of the present invention;

FIG. 2 is a schematic representation of the architecture of the LIDAR system of FIG. 1, with the transmitter having an optical waveguide having a set of partially reflective surfaces deployed within the waveguide for performing aperture expansion, and with the transmitter and the receiver deployed in a common aperture configuration, according to an embodiment of the present invention;

FIG. 3 is a schematic representation similar to FIG. 2, but with the transmitter and receiver deployed in a non-overlapping aperture configuration, according to an embodiment of the present invention;

FIG. 4 is a schematic representation similar to FIG. 2, but further including a diffractive optical element deployed at the output of the optical waveguide, according to an embodiment of the present invention;

FIG. 5 is a front view illustrating a schematic representation of an optical waveguide of the transmitter having an embedded set of partially reflective surfaces for performing aperture expansion, according to an embodiment of the present invention;

FIGS. 6A and 6B are side and bottom views, respectively, illustrating schematic representations of an optical waveguide of the transmitter having an embedded set of partially reflective surfaces for performing two-dimensional aperture expansion, according to an embodiment of the present invention;

FIG. 7 is a front view illustrating a schematic representation of two optical waveguides of the transmitter, with the first optical waveguide having a first set of partially reflective surfaces for performing two-dimensional aperture expansion, and the second optical waveguide having a second set of partially reflective surfaces for performing one-dimensional aperture expansion, according to an embodiment of the present invention;

FIG. 8 is a front view illustrating a schematic representation of an optical waveguide of the transmitter having a first set of partially reflective surfaces for performing aperture expansion in a first dimension and a second set of partially reflective surfaces for performing aperture expansion in a second dimension, according to an embodiment of the present invention;

FIG. 9 is a schematic representation similar to FIG. 2, but having a scanning arrangement deployed at the output of the optical waveguide, according to an embodiment of the present invention; and

FIG. 10 is a block diagram of the processing subsystem of the LIDAR system that is configured to process signals from a detector of the receiver to derive information associated with the object located in the scene.

### DESCRIPTION OF THE PREFERRED EMBODIMENTS

The present invention is a detection and ranging system employing an optical waveguide.

The principles and operation of the system according to present invention may be better understood with reference to the drawings accompanying the description.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways.

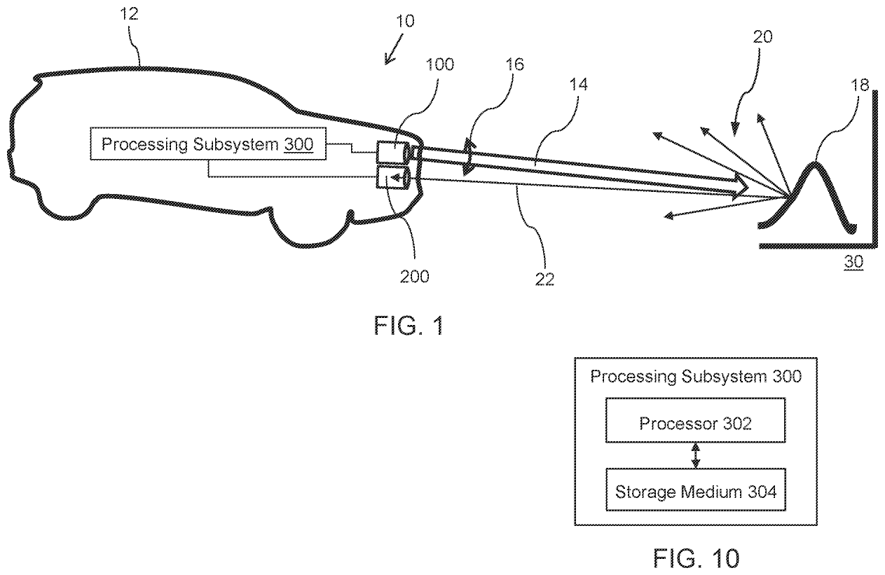

Referring now to the drawings, FIG. 1 illustrates a light detection and ranging (LIDAR) system (referred to interchangeably as the “system”), generally designated 10, according to a non-limiting embodiment of the present invention. In the illustrated embodiment, the system 10 is deployed in a ground-based motor vehicle 12 which can be an autonomous vehicle (i.e., a “self-driving car”), a driver-operated vehicle, or a computer-assisted driver-operated vehicle (i.e., a “semi-autonomous vehicle”). Although the vehicle 12 is schematically illustrated as an automobile, the vehicle 12 may be implemented as any type of vehicle in which a LIDAR system can be deployed, including, but not limited to, motorcycles, motorbikes, electric bikes, electric scooters, and the like, as well as military ground-based vehicles (e.g., armored personnel carriers, trucks, armored fighting vehicles, etc.). Furthermore, in certain embodiments all or some of the components of the system 10 of the present invention may be deployed separate from the vehicle, for example as part of a helmet or other head-mounted gear, which can be of particular use when the system 10 is deployed for use with vehicles in which the driver/operator wears a helmet or head-mounted gear while operating the vehicle, for example motorcycles and the like.

Generally speaking, the system 10 includes a light transmitter subsystem 100 (referred to interchangeably herein as a “transmitter subsystem” or “transmitter”) for generating and directing collimated light, represented here schematically by a beam of illumination 14, toward a scene 30 (also referred to as a “region of interest”, “field of interest” or “field of view of interest”), a light receiver subsystem 200 (referred to interchangeably herein as a “receiver subsystem” or “receiver”) for receiving light reflected or backscattered from an object 18 in the scene 30 in response to illumination from the transmitter 100, and a processing subsystem 300 associated with the transmitter subsystem 100 and the receiver subsystem 200 for controlling some of the components of the transmitter subsystem 100 and for processing signals from the receiver subsystem 200 to derive information associated with the object 18.

The scene is generally considered to be whatever scenery is in front of the transmitter 100 that can be illuminated by the transmitter 100. When the system 10 is deployed for use with a vehicle, the scene 30 is generally considered to be whatever scenery is in front of the vehicle that can be illuminated by the transmitter 100. In the context of vehicle deployment, objects in the scene that can be detected and imaged by the system 100 include, for example, other vehicles, pedestrians, cyclists, trees, rocks, street signs, street lights, or any other solid body or obstruction in the path of the vehicle.

The beam 14 is scanned vertically and horizontally (laterally) across the field of interest by a scanning arrangement of the transmitter subsystem 100. The scanning beam 14 is designated by the double-headed arrow labeled as 16 in FIG. 1. Note that the lateral scanning is in and out of the plane of the paper, and therefore the lateral scanning is not discernible in FIG. 1. The beam 14, upon impinging on the object 18, is reflected or backscattered by the object 18 as reflected light. represented here schematically by multiple rays of light 20. Some of the reflected light 20, represented here schematically by light ray 22, reaches the receiver subsystem 200 so as to be detected by receiver subsystem 200 (in particular a photodetector, as will be discussed in further detail below). The processing subsystem 300 processes signals from the receiver subsystem 200 so as to derive information associated with the object 18, for example, time-of-flight (TOF) information, range (i.e., distance) information (based on TOF), and direction of arrival information. In certain embodiments, this information can he used by the processing subsystem 300 to construct a three-dimensional (3D) representation of the object 18 (i.e., a point cloud), which can then be used to render a 3D image of the object 18.

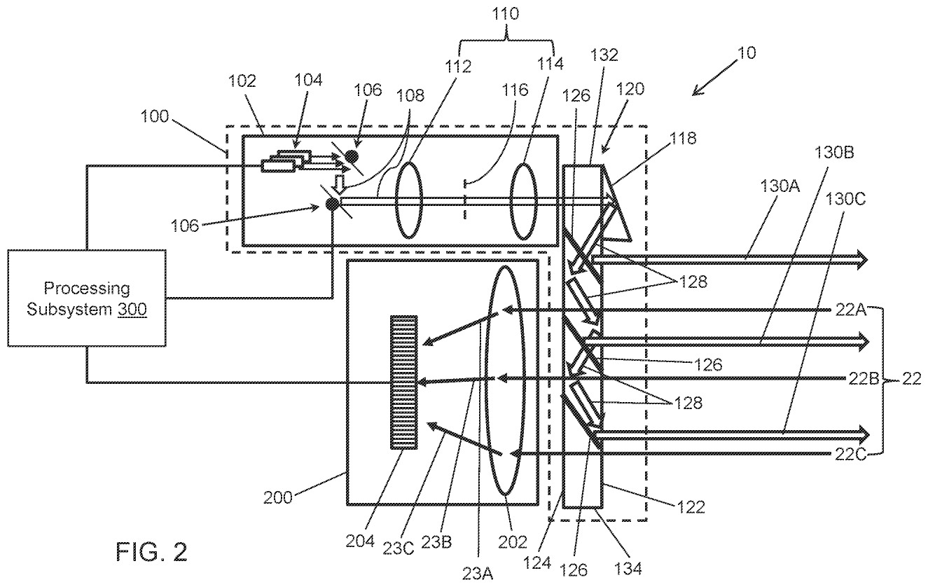

Referring now to FIG. 2., there is shown a schematic representation of the system 10 according to a non-limiting embodiment of the present invention. The transmitter 100 includes an illumination and beam combining unit 102, an optical waveguide 120, and an optical coupling-in configuration 118 for coupling light from the illumination and beam combining unit 102 into the optical waveguide 120. The optical waveguide 120 is a light-transmitting substrate formed from a transparent material (such as glass) having a plurality of faces including at least a pair of preferably parallel faces (also referred to herein as “major external surfaces”) 122, 124 for guiding light by internal reflection. The optical waveguide 120 is deployed with one of the faces 122 in facing relation to a scene, such as the scene 30 containing the object 18 illustrated in FIG. 1. The receiver 200 preferably includes focusing optics 202 for receiving light 22 reflected from objects in the scene (e.g., the object 18) and converting the received light into converging beams of captured light, and a photodetector (referred to interchangeably as a “detector” or “optical sensor”) 204 for sensing the captured light and generating a signal indicative of at least one parameter (intensity) of the captured light.

The illumination and beam combining unit 102 includes an illumination arrangement 104 deployed to emit beams of light for coupling into the optical waveguide 120. The illumination arrangement 104 includes at least one beam source, preferably at least two beam sources, and more preferably at least three beam sources. The beam sources (referred to interchangeably herein as “light sources”, “illumination sources” or “sources of light”) are preferably implemented as a set (i.e., plurality) of laser sources, such as, for example, laser diodes, fiber lasers, or microchip lasers, each configured to generate (i.e., produce) a corresponding coherent beam of laser illumination.

In certain non-limiting implementations, laser sources are deployed side by side so as to emit separate beams of laser light in a common direction that form a combined beam. In other non-limiting implementations, the illumination arrangement 104 further includes a beam combiner (not shown), and laser sources are deployed at various positions relative to the beam combiner so as to combine the beams from the individual beam sources as a combined beam. Beam combiners are well-known in the art and can be implemented in various ways, using, for example, beamsplitter arrangements, dichroic mirrors, prisms, and the like.

In certain non-limiting embodiments, one of the beam sources is implemented as a visible light laser source configured to produce laser light in the visible region of the electromagnetic spectrum, and the remaining beam sources are implemented as NIR laser sources configured to produce laser light at different respective wavelengths in the NIR region of the electromagnetic spectrum. In one set of preferable but non-limiting implementations, the beam sources are implemented as a set of two or three modulated NIR laser sources and a visible light laser source placed side by side or combined via a beam combiner. The visible light laser source can be modulated for range detection or modulated so as not to transmit simultaneously during the MR laser transmission. Alternatively, the visible light laser can be configured to operate in a continuous wave (CW) mode. The visible light laser source is preferably configured to produce light having wavelength corresponding to a color that is easily discernible by the human eye, for example a wavelength in the range of 420-680 nm. In embodiments in which the NIR laser sources produce light at different respective wavelengths, three MR laser sources emitting light at around 940 nm (e.g., 935 nm, 940 nm, and 935 nm, respectively), in combination with a visible light laser source has been found to particularly suitable for the LIDAR applications. It is noted that a significantly high proportion of solar radiation intensity at wavelengths around 940 nm is typically absorbed by the atmosphere, and therefore sunlight illumination around 940 nm tends not to impinge on the optical sensor, or to impinge on the optical sensor at a relatively low intensity compared to the intensity of light that is to be detected by the optical sensor. It is also noted that all of the beam sources may emit beams at the same wavelength (e.g., all at 940 nm). Furthermore, although a visible light laser can be used in combination with NIR lasers for eye-safety purposes, it is also possible to utilize eye-safe lasers that are outside of the NIR and visible regions. For example, lasers at the lower end of the short-wavelength infrared (SWIR) region, in particular around 1550 nm, are more eye-safe than lasers in the NIR region.

The use of beam sources that emit light at different respective wavelengths enables the receiver 200 to detect a wide variety of materials since certain types of materials may have a greater spectral response to certain wavelengths than to other wavelengths. For example, plants typically exhibit higher reflection of light at wavelengths around 700 nm. The variation in spectral response may also enable mapping of the scene, by the processing subsystem 300, by identifying wavelength-dependent changes in the intensity of signal generated by the detector 204.

The illumination arrangement 104, in addition to having the beam sources, and in certain instances a beam combiner, may also include various components that can be used to modify beam parameters of the beams produced by the beam sources. Such components include, but are not limited to, modulators for modulating beam intensity and/or phase and/or frequency, and amplifiers for amplifying the intensity signal of the generated beams. In certain non-limiting implementations, each beam source is associated with a modulator and an amplifier. In other implementations, only some of the beam sources are associated with a modulator and/or an amplifier.

Transmission timing of the beam sources, as well as modulation and/or amplification of the beams generated by the beam sources, is preferably controlled by the processing subsystem 300. In certain embodiments, the beams produced by the beam sources are coherently combined, and each beam source has an associated phase modulator that allows adjustment of the relative phase offsets between the beams so as to maintain phase coherence of the beams. In such embodiments, the processing subsystem 300 measures the relative phase offsets between the beams and actuates the phase modulators to adjust the phase offsets.

The light emitted by the illumination arrangement 104 may be unpolarized, or may be polarized. To produce polarized light, the illumination arrangement 104 may include a linear polarizer deployed at the output of the beam sources or at the output of the beam combiner such that the combined beam passes through the linear polarizer. In cases where the beam sources themselves are polarized sources, such a linear polarizer is not needed.

The combined beam from the beam sources, represented schematically by the thick arrow and generally designated 108, is scanned by a scanning arrangement 106. The scanning arrangement 106 preferably includes optical components that divert (i.e., deflect) incoming beams, as well as electro-mechanical components (e.g., electro-mechanical actuators) for adjusting the position and/or orientation of the optical components to effectuate divergence of the beams in a desired direction. The scanning arrangement 106 can be implemented as any suitable beam diverging or beam steering mechanism, including, for example, a single scanning or tilting mirror that performs scanning in two orthogonal dimensions (e.g., vertical and horizontal/lateral), a pair of orthogonal single axis scanning or tilting mirrors, and a set of prisms with one or more of the prisms being rotatable/tiltable about one or more axis of rotation/tilt. Preferably, the scanning arrangement 106 is electrically associated with the processing subsystem 300, which controls the scanning action of the scanning arrangement 106.

Collimating optics 110 is deployed in the optical path between the scanning arrangement 106 and the optical waveguide 120. The collimating optics 110 includes at least one optical component that collimates the scanned beam 108 onto the output aperture (i.e., exit pupil) of the illumination and beam combining unit 102. In the illustrated embodiment, the collimating optics 110 includes a pair of collimating optical elements, represented schematically as lenses 112, 114, which form an intermediate image plane 116 between the lenses 112, 114. In certain non-limiting implementations, a micro-lens array (MLA) or a diffuser is deployed at the image plane 116 to fit the exit pupil of the illumination and beam combining unit 102 to the entrance pupil (i.e., input aperture) of the optical waveguide 120. This aperture fitting by the MLA or diffuser spreads the intensity of the beam 108 across the input aperture of the optical waveguide 120, thereby reducing the overall intensity of the beam 108 that is to be coupled into the optical waveguide 120. The reduced intensity of the beam 108 further increases eye-safety, and therefore preferred implementations employ the MLA or diffuser for aperture fitting. The collimating optics 110 also generates pupil imaging between the plane of the scanning arrangement 106 and the exit pupil plane of the illumination and beam combining unit 102 (adjacent to the optical coupling-in configuration 118) such that all of the scanned beams are transmitted through the exit pupil of the illumination and beam combining unit 102 and enter the optical waveguide 120. It is noted that the illumination arrangement 104 may itself have a small exit pupil, and therefore using an MLA may not be necessary unless a uniform output beam is needed. It is also noted that in certain embodiments the illumination arrangement 104 may include collimating optics, such that the combined beam 108 from the beam sources is a collimated beam. For example, certain beam combiners employ embedded collimating optics such that the individual beams, in addition to being combined by the beam combiner, are also collimated by the beam combiner. In such embodiments, collimating optics 110 may not be necessary, or may be used to re-collimate the beam 108 if the beam becomes de-collimated due to the scanning by the scanning arrangement 106.

The scanned and collimated beam from the illumination and beam combining unit 102 is coupled into the optical waveguide 120 by the optical coupling-in configuration 118, represented here schematically as a suitably angled coupling prism. Other suitable optical coupling-in configurations for coupling illumination into the optical waveguide 120, such as by use of a coupling-in reflector or a diffractive optical element, are well-known in the art. The coupled in beam propagates (i.e., is guided) through the optical waveguide 120 by repeated internal reflection at the faces 122, 124. The propagating beam is represented schematically by the thick arrow and generally designated 128. In certain preferred but non-limiting implementations, the propagation through the optical waveguide 120 by internal reflection is in the form of total internal reflection (TIR), whereby incidence of the illumination (beam 128) at the faces 122, 124 at angles greater than a critical angle causes reflection of the illumination at the faces 122, 124. As is well-known in the art, the critical angle is defined by the refractive index of the material from which the optical waveguide 120 is constructed and refractive index of the medium in which the optical waveguide 120 is deployed (e.g., air). In other non-limiting implementations, the propagation through the optical waveguide 120 by internal reflection is effectuated by a reflective coating (e.g., an angularly selective reflective coating) applied to the faces 122, 124.

The beam 128 propagates within the optical waveguide 120 and impinges on an optical coupling-out configuration associated with the optical waveguide 120, which in the illustrated embodiment is implemented as a sequence of parallel partially reflective surfaces 126 deployed within the optical waveguide 120 at an oblique angle to the faces 122, 124, where part of the intensity of the beam 128 is reflected so as to be coupled out of the optical waveguide 120 towards a scene (e.g., the scene 30 in FIG. 1). The partially reflective surfaces 126 may be evenly spaced along the direction of elongation of the optical waveguide 120 (which in FIG. 1 is the vertical direction), or may be unevenly spaced. The partially reflective surfaces 126 are generally formed from thin transparent plates that are coated with suitable coatings that provide the desired reflectivity pattern. In certain non-limiting embodiments, the coatings are dielectric coatings, while in other embodiments the coatings include portions of a metallic material (such as silver) deployed in a prescribed pattern on the transparent plates. The portions of metallic material can assume a variety of shapes, depending on the desired reflectivity pattern, including, for example, circular dots, oblong-shaped dots, and lines.

It is noted that the partially reflective surfaces 126 are merely illustrative of one non-limiting optical coupling-out configuration suitable for use with the optical waveguide 120, and other optical coupling configurations can be used to couple illumination out of the optical waveguide 120. The optical coupling-out configuration may be any optical coupling arrangement which deflects part of the illumination propagating within the optical waveguide 120 by internal reflection to an angle such that the deflected part of the illumination exits the optical waveguide 120. Other examples of such suitable optical coupling arrangements include, but are not limited to, one or more diffractive optical elements deployed on either of the faces 122, 124.

In the non-limiting implementation illustrated in FIG. 2, each of the partially reflective surfaces 126 reflects (couples-out) a proportion of the guided beam 128 out of the optical waveguide 120 towards the scene, where the reflected beams are represented schematically by beams 130A, 130B, 130C (which correspond to the scanned beam 14 that is directed towards the scene 30 in FIG. 1). In certain non-limiting implementations, the reflectivity of the partially reflective surfaces increases along the direction of elongation of the optical waveguide 120 from a proximal end of the optical waveguide 120, that is adjacent to the optical coupling-in configuration 118, to a distal end generally opposite the proximal end. In a particularly preferred but non-limiting implementation, the last partially reflective surface (e.g., the partially reflective surface that reflects the illumination 128 so as to generate coupled-out beam 130C) is fully reflective (i.e., 100% reflectivity).

The effect of the optical waveguide 120 and the optical coupling-out configuration on the beam 108 from the illumination and beam combining unit 102 is that the output aperture (exit pupil) of the illumination and beam combining unit 102 is multiplied (i.e., expanded) as the beam 128 propagates within the optical waveguide 120 and is coupled out of the optical waveguide 120. This aperture expansion (aperture multiplication) can be in one dimension (as is the case in the non-limiting implementation of the optical waveguide 120 in FIG. 2), or can be in two dimensions.

Details of optical waveguides used in near-eye displays that perform one-dimensional aperture expansion of image illumination generated by image projectors having small output aperture for coupling-out to an eye of an observer can be found in various commonly owned issued patents, including the following which are hereby incorporated by reference in their entireties herein: U.S. Pat. Nos. 6,829,095, 7,577,326, 7,724,444, 7,751,122, 9,551,880, and 9,025,253. Details of optical waveguides used in near-eye displays that perform two-dimensional aperture expansion of image illumination generated by image projectors having small output aperture for coupling-out to an eye of an observer can be found in various commonly owned issued patents, including the following which are hereby incorporated by reference in their entireties herein: U.S. Pat. Nos. 10,133,070 and 10,551,544.

It is noted that although the faces 122, 124 are preferably mutually parallel, the requirement for parallelism is less strict for optical waveguides that are used in non-display applications, such as the optical waveguide 120 of the present embodiments in which the optical waveguide is used to illuminate a scene with laser illumination covering a desired angular range. This is in contrast to the optical waveguides in the commonly owned patents mentioned above, where any deviation of parallelism between pairs of major external surfaces will cause the image illumination that propagates through the waveguide to form non-conjugate image sets, resulting in degraded quality of the image that is coupled out of the optical waveguide to the eye of the observer.

It is noted that in many LIDAR system configurations, referred to as “common aperture” configurations, the receiver unit is located at the same aperture as the emitter unit. Benefits of systems that use common aperture configurations include lack of parallax effects that perturb the LIDAR system, and a more compact system. The non-limiting embodiment of the system 10 illustrated in FIG. 2 utilizes a common aperture configuration. Here, the receiver 200 is associated with the face 124 of the optical waveguide 120 so as to be located behind the optical waveguide 120. The input aperture of the system 10, which is the input aperture of the receiver 200 and is generally defined by the focusing optics 202, is contained within (i.e., fully overlapping with) the output aperture of the system 10, which is the output aperture of the transmitter 100 and is generally defined by the combination of the optical waveguide 120 and the optical coupling-out configuration (e.g., the distribution of the partially reflective surfaces within the optical waveguide 120). The reflected light 22 from the scene (i.e., the light reflected by the object in the scene), represented here as light rays 22A, 22B, 22C, passes through the optical waveguide 120 so as to be received by the focusing optics 202, which is associated with the face 124. In particular, the light 22 is transmitted by the face 122, passes through the partially reflective surfaces 126, and is transmitted by the face 124 to the focusing optics 202. In configurations in which the partially reflective surfaces 126 are deployed in spaced relation so as to be non-overlapping and discontinuous (i.e., there is a space between where one partially reflective surface ends and the next partially reflective surface begins) some or all of the light 22A, 22B, 22C may pass directly through the optical waveguide 120 by passing through the empty spaces between pairs of adjacent partially reflective surfaces. In other configurations, a proportion of the intensity of the light 22A, 22B, 22C may be transmitted by the partially reflective surfaces 126 so as to pass through the partially reflective surfaces to the focusing optics 202.

The focusing optics 202, represented schematically as a lens (but which may include a set of lenses), is deployed in an optical path between the scene and the photodetector 204. The focusing optics 202 receives the light 22A, 22B, 22C from the scene (i.e., reflected by the illuminated object in the scene) and converts the received light 22A, 22B, 22C into converging beams of light (represented schematically as light rays 23A, 23B, 23C) that impinge on the detector 204. In certain implementations, the focusing optics 202 forms an image of the object on the detector 204. The focusing optics 202 is preferably deployed to define a field of view corresponding to the region or portion of the scene that is illuminated by the transmitter 100 so as to enable the capture of light reflected from objects in the illuminated scene. In certain embodiments, a passband spectral filter may be deployed in the optical path from the scene to the detector 204 to obstruct light of wavelengths outside a given range of wavelengths within which the illumination from the illumination arrangement 104 is generated from reaching the detector 204. The spectral filter may ideally be positioned between the focusing optics 202 and the detector 204, but may alternatively be deployed between the face 124 and the focusing optics 202.

The external surfaces (i.e., faces 122, 124) of the optical waveguide 120 are preferably coated with an anti-reflection coating in order to prevent the optical waveguide 124 from scattering light that is emitted by the transmitter 100 back to the receiver 200.

In embodiments where the illumination arrangement 104 emits polarized light, the partially reflective surfaces are preferably polarization sensitive, whereby the proportion of the intensity of polarized light that is reflected by the partially reflective surfaces depends on the polarization direction of the propagating beam. In embodiments in which the transmitted beams 130A, 130B, 130C are polarized, a polarizer (not shown) is preferably deployed in the optical path between the receiver 200 and the optical waveguide 120 (for example, in association with the face 124) so as to substantially suppress saturation of the receiver 200. Note that such suppression may come at the expense of 50% transmittance of the light 22 from the scene,

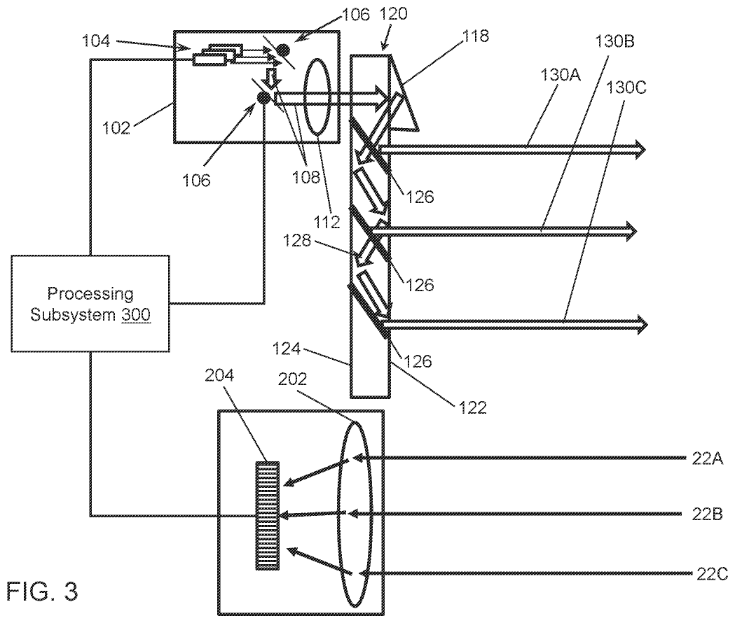

With continued reference to FIGS. 1 and 2, refer now to FIG. 3, which shows a schematic representation of the system 10 according to another non-limiting embodiment of the present invention, generally similar to the embodiment described with reference to FIG. 2, but with a “non-overlapping aperture” configuration. Here, the receiver 200 is positioned adjacent to the transmitter 100, such that the input aperture of the system (i.e., the input aperture of the receiver 200) is separate from the output aperture of the system (i.e., the output aperture of the transmitter 100). Although this configuration results in a less compact system, such a configuration may be of particular value in situations in which residual reflections from the illumination and beam combining unit 102 are expected to saturate the receiver 200.

In addition to having non-overlapping apertures, the embodiment illustrated in FIG. 3 has a simplified illumination and beam combining unit 102. Here, collimating optics has only a single collimating optical element 112 such that there is no intermediate image plane. As a result, no pupil imaging is performed by the collimating optics, and the exit pupil of the illumination and beam combining unit 102 does not overlap with the entrance pupil of the optical waveguide 120. The simplified structure of the illumination and beam combining unit 102 in the illustrated embodiment can be used in particular if the exit pupil of the illumination and beam combining unit 102 is much smaller than the entrance pupil to the optical waveguide 120 such that the beam 108 at the output of the illumination and beam combining unit 102 travels across the entrance pupil to the optical waveguide 120 but stays within the optical waveguide 120 such that minimal energy is lost. The requisite difference in size between the exit pupil of the illumination and beam combining unit 102 and the entrance pupil of the optical waveguide 120 can be effectuated, for example, by producing a narrow beam 108 to decrease the size of the exit pupil of the illumination and beam combining unit 102, and/or increasing the thickness of the optical waveguide 120 (i.e., the distance between the faces 122, 124) to increase the size of the entrance pupil of the optical waveguide 120.

It is noted that the receiver 200 can be deployed relative to the transmitter 100 such that a portion of the focusing optics 202 is associated with the face 124 (i.e., a portion of the focusing optics 202 is located behind the optical waveguide 120) and the remaining portions of the focusing optics 202 is positioned adjacent to the optical waveguide 120. In such a deployment, the input aperture of the receiver 200 defined by the focusing optics 202 is partially overlapping with the output aperture of the transmitter 100.

In the non-limiting embodiments illustrated in FIGS. 2 and 3, the scanning arrangement 106 scans the transmitted field by deflecting light from the illumination arrangement 104 so that the scanning beam 108 impinges on the optical coupling-in configuration 118 at varied angles of incidence such that the illumination from the illumination arrangement 104 is coupled into the optical waveguide 120 at a corresponding range of coupling-in angles. The angular scanning spread of the beam 108 at the optical coupling-in configuration 118 results in a corresponding angular spread of the propagating beam 128, such that the output beams 130A, 130B, 130C are coupled out of the optical waveguide 120 at a range of corresponding angles so as to scan the scene with the illumination.

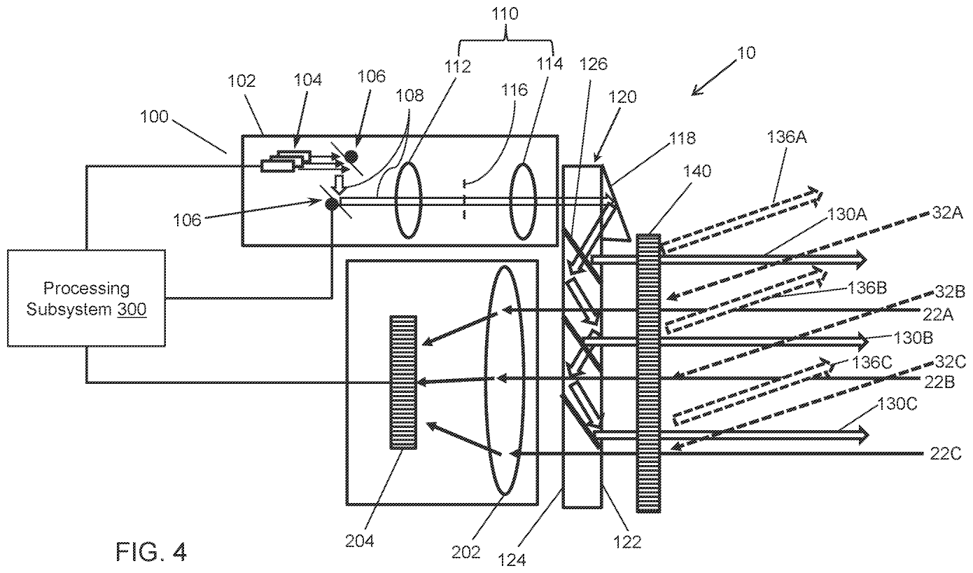

One method of increasing the angular range of the output beams is illustrated in FIG. 4, which shows a schematic representation of the system 10 according to yet another non-limiting embodiment of the present invention. The embodiment illustrated in FIG. 4 is generally similar to the embodiment illustrated in FIG. 2 except that a diffractive optical element 140, such as one or more diffractive grating, is deployed in front of the output aperture of the transmitter 100 (i.e., in association with the face 122, and between the face 122 and the scene). In certain non-limiting implementations, the diffractive optical element 140 is mechanically positioned adjacent to the face 122 so as to be associated with the face 122, and spans across the entire coupling-out region of the face 122, which is defined as the portion of the face 122 spanned by the projection of the partially reflective surfaces 126 in a projection plane that is parallel to the plane of the face 122. Preferably, the diffractive optical element 140 spans across the majority of the length of the face 122 (the length being in the vertical direction in FIG. 4) so as to cover at least 80% of the length of the face 122 and more preferably at least 90% of the length of the face 122.

In the illustrated embodiment, the beam sources operate at different respective wavelengths (i.e., the light emitted by each beam source has a different respective wavelength) and the combined beam 128 does not disperse as it propagates through the optical waveguide 120. When the coupled-out beams 130A, 130B, 130C pass through the diffractive optical element 140, the beams 130A, 130B, 130C are dispersed by the diffractive optical element 140 to generate corresponding dispersed beams, represented schematically by the thick dashed arrows and generally designated 136A, 136B, 136C, thereby increasing the angular range covered by the beams 130A, 130B, 130C, 136A, 136B, 136C. When using a common aperture configuration, as illustrated in FIG. 4, the diffractive optical element 140 also diverts additional reflected light from the scene, represented here as light rays 32A, 32B, 32C, toward the receiver 200 so as to be captured by the detector 204. It is noted that although FIG. 4 illustrates a common aperture configuration, the diffractive optical element 140 can be used in a non-overlapping aperture configuration, similar to as illustrated in FIG. 3, such that the diffractive optical element 140 is not deployed in front of the receiver 200. In such an embodiment, the diffractive optical element 140 only diverts the output beams 130A, 130B, 130C (so as to generate corresponding beams 136A, 136B, 136C) and does not divert any of the incoming light from the scene toward the receiver 200.

As mentioned above, the optical waveguide 120 can be implemented in various ways to enable expansion of the input aperture in one dimension or two dimensions. The following paragraphs describe various implementation options of the optical waveguide 120 so as to enable aperture expansion and scanning of the scene by the coupled-out beams.

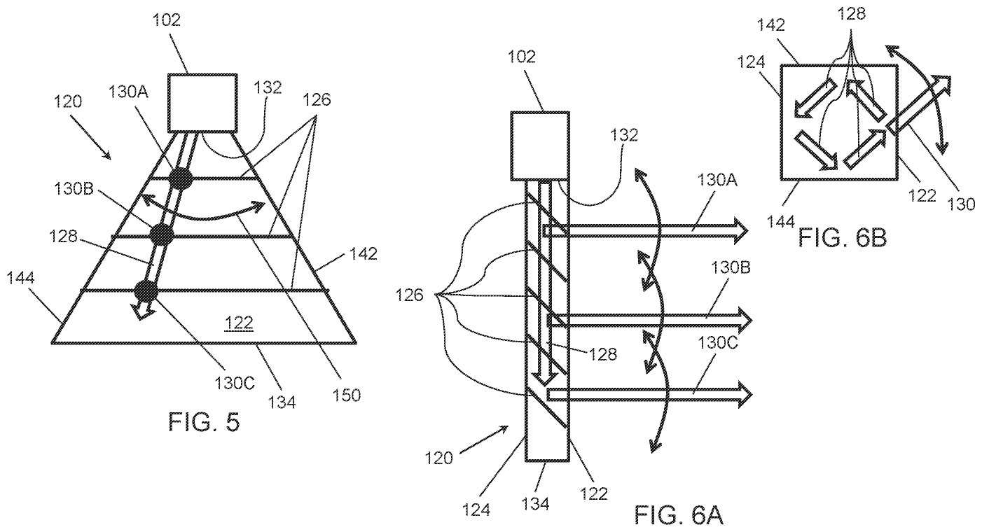

With continued reference to FIGS. 2-4, refer also to FIG. 5, which shows a front view of the optical waveguide 120 according to a non-limiting embodiment of the present invention. While the optical waveguide 120 has a rectangular cross-section (assuming parallelism between the faces 122, 124) in a first plane (the plane of paper in FIGS. 2-4), the face 122 itself is trapezoidal shaped, such that the optical waveguide 120 has a trapezoidal cross-section in the coupling-out plane (orthogonal to the first plane). Here, the top and bottom parallel faces 132, 134 are of different lengths such that left and right side faces 142, 144 are tapered inward. The coupled-in beam 128 propagates by internal reflection between the faces 122, 124, but is also coupled-in at a range of angles in the vertical direction in FIG. 2, corresponding to lateral scanning of the beam 128 in FIG. 5 (in and out of the page in FIGS. 2-4), where the laterally scanning of the beam 128 is designated by the double-headed arrow labeled as 150 in FIG. 5. The coupled-out beams (coming out of the page in FIG. 5) are represented by the black filled circles designated 130A, 130B, 130C. Vertical scanning of the beams is also existent, effectuated by the angular scanning spread of the beam 108 at the optical coupling-in configuration 118 as discussed above, but is not discernible in the front view shown in FIG. 5.

FIGS. 6A and 6B show schematic side and bottom views, respectively, of an implementation of the optical waveguide 120 according to another non-limiting embodiment of the present invention. Here, the optical waveguide 120 has a direction of elongation illustrated arbitrarily as corresponding to the vertical direction, and includes two pairs of parallel faces 122, 124, 142, 144 forming a rectangular cross-section. The partially reflecting surfaces 126 at least partially traverse the optical waveguide 120 at an oblique angle to the direction of elongation. The optical coupling-in configuration (not illustrated here) and the illumination and beam combining unit 102 are deployed relative to the optical waveguide 120 so as to couple an input beam (e.g., beam 108 in FIGS. 2-4) into the optical waveguide 120 with an initial direction of propagation at a coupling angle oblique to both the first and second pairs of parallel faces 122, 124, 142, 144, the beam 128 advances by four-fold internal reflection along the optical waveguide 120 (i.e., in a helical manner so as to propagate in two dimensions), with a proportion of intensity of the beam 128 reflected at the partially reflecting surfaces 126 so as to be coupled out of the optical waveguide 120 toward the scene. The effect of the helical propagation of the beam 128 on the coupled-out beams 130A, 130B, 130C (generally designated 130 in FIG. 6B) is that the coupled-out beams effectively scan the scene both vertically (as indicated by the double-headed arrows in FIG. 6A) and laterally (as indicated by the double-headed arrow in FIG. 6B).

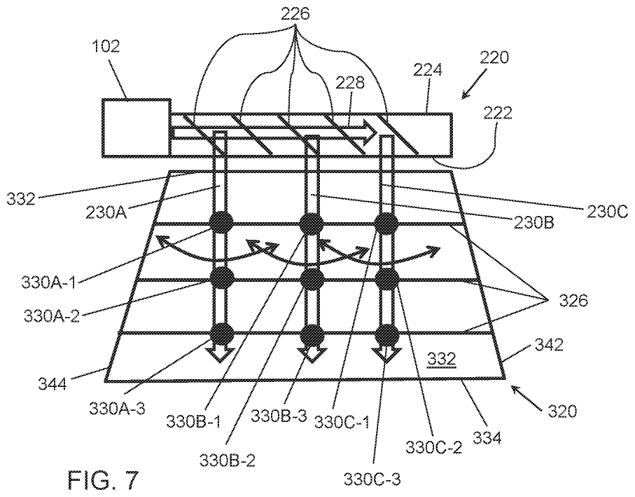

FIG. 7 shows a configuration according to another non-limiting embodiment of the present invention, in which a pair of optical waveguides 220, 320 are used in order to perform vertical and lateral scanning. Here, the first optical waveguide 220 is similar to the optical waveguide described with reference to FIGS. 6A and 6B, and the second optical waveguide 320 is similar to the optical waveguide described with reference to FIG. 5. The first optical waveguide 220 has a direction of elongation illustrated arbitrarily as corresponding to the horizontal direction, and two pairs of parallel faces forming a rectangular cross-section. Only one pair of parallel faces 222, 224 is shown in FIG. 7, but a second pair of parallel faces, similar to faces 142, 144 in FIG. 6B, is also present. A plurality of partially reflecting surfaces 226 at least partially traverse the first optical waveguide 220 at an oblique angle to the direction of elongation. The second optical waveguide 320 is optically coupled to the first optical waveguide 220 and has a pair of parallel faces (only one of the faces 332 is shown in FIG. 7), and is deployed with the face 332 in facing relation to the scene that is to be illuminated. The second optical waveguide 320 further includes top and bottom parallel faces 332, 334, as well as left and right side faces 342, 344. Similar to as in FIG. 5, the faces 332, 334 are of different lengths such that side faces 342, 344 are tapered inward. Here too a plurality of partially reflective surfaces 326 at least partially traverse the second optical waveguide 320 at an oblique angle to the faces 332. The partially reflective surfaces 226 and 326 are deployed such that the partially reflective surfaces 226 lay in a first set of mutually parallel planes, and the partially reflective surfaces 326 lay in a second set of mutually parallel planes that are oblique to the first set of planes.

The optical coupling between the optical waveguides 220, 320, the deployment and configuration of the partially reflective surfaces 226, 326, and the deployment of the coupling-in configuration (not illustrated here) and the illumination and beam combining unit 102 are such that, when the output beam from the illumination and beam combining unit 102 (e.g., the beam 108 in FIGS. 2-4) is coupled into the first optical waveguide 220 with an initial direction of propagation at a coupling angle oblique to both pairs of parallel faces of the first optical waveguide 220, the coupled-in beam 228 advances by four-fold internal reflection along the optical waveguide 220, with a proportion of intensity of the beam 228 reflected at the partially reflecting surfaces 226 so as to be coupled into the second optical waveguide 320 as illumination (schematically represented by beams 230A, 230B, 320C), and then propagates by two-fold internal reflection within the second optical waveguide 320 (i.e., between the face 332 and the other face that is parallel to the face 332), with a proportion of intensity of the illumination 230A, 230B, 320C reflected at the partially reflective surfaces 326 so as to be coupled out of the second optical waveguide 320 (via the face 332) toward the scene. The beams that are coupled out of the second optical waveguide 320 by the partially reflective surfaces 326 (coming out of the page in FIG. 7) are represented by the black filled circles designated 330A-1, 330A-2, 330A-3, 330B-1, 330B-2, 330B-3, 330C-1, 330C-2, 330C-3. Here, scanning effectuated by the first optical waveguide 220 is reinforced by the lateral imparted by the second optical waveguide 320 (lateral scanning indicated by the double-headed arrows in FIG. 7).

As should be apparent the two-dimensional aperture expansion performed by the optical waveguides described with reference to FIGS. 6A-7 generates a greater number of pupil images and reduces the concentration of the illumination intensity as compared with optical waveguides that perform one-dimensional aperture expansion.

Further details of the structure and operation of optical waveguides that are similar in structure to the optical waveguides described with reference to FIGS. 6A-7 can be found in the above-mentioned U.S. Pat. No. 10,133,070.

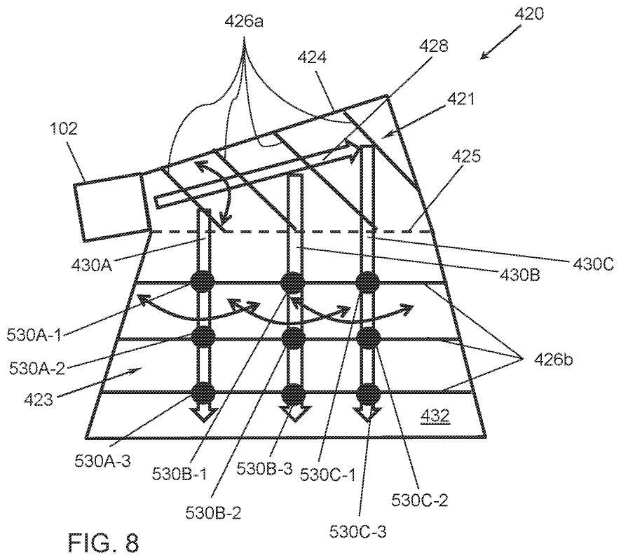

FIG. 8 shows a schematic front view of an optical waveguide 420 according to another non-limiting embodiment of the present invention. Here, the optical waveguide 420 is composed of two substrate sub-sections, namely a first waveguide section 421 and a second waveguide section 423. The dashed line represents the plane 425 that separates the two sections 421, 423. As can be seen from the drawing, both sections 421, 423 have a trapezoidal shape in the coupling-out plane of the optical waveguide 420, where the coupling-out plane is represented by the planar face 432.

A first set of partially reflective surfaces 426a is deployed in the first section 421 of the optical waveguide 420 oblique to the planar face 424 and the plane 425, and a second set of partially reflective surfaces 426b is deployed in the second section 423 of the optical waveguide 420 oblique to the face 432. In addition, the planes containing the partially reflective surfaces 426a are oblique or perpendicular to the planes containing the partially reflective surfaces 426b.

The deployment and configuration of the partially reflective surfaces 426a, 426b, and the deployment of the coupling-in configuration (not illustrated here) and the illumination and beam combining unit 102 are such that, when the output beam from the illumination and beam combining unit 102 (e.g., the beam 108 in FIGS. 2-4) is coupled into the first section 421 of the optical waveguide 420, the coupled-in beam 428 propagates through two-fold internal reflection within the first section 421 between the planes 424, 425 in a first guided direction, with a proportion of intensity of the beam 428 reflected at the partially reflecting surfaces 426a so as to be coupled into the second section 423 of the optical waveguide 420 as illumination schematically represented by beams 430A, 430B, 420C), and then propagates through two-fold internal reflection within the second section 423 of the optical waveguide 420 between the face 432 and the other face that is parallel to the face 432 (not discernible in FIG. 8) in a second guided direction (oblique to the first guided direction), with a proportion of intensity of the illumination 430A, 430B, 430C reflected at the partially reflective surfaces 426b so as to be coupled out of the second section 423 of the optical waveguide 420 (via the face 432) toward the scene. The beams that are coupled out of the second section 423 of the optical waveguide 420 by the partially reflective surfaces 426b (coming out of the page in FIG. 8) are represented by the black filled circles designated 530A-1, 530A-2, 530A-3, 530B-1, 530B-2, 530B-3, 530C-1, 530C-2, 530C-3. In the illustrated configuration, the first section 421 and the first set of partially reflective surfaces 426a effectuate aperture expansion in a first dimension, i.e., lateral aperture expansion and beam scanning (represented by the double-headed arrow in the first section 421), and the second section 423 and the second set of partially reflective surfaces 426b effectuate aperture expansion in a second dimension (orthogonal to the first dimension), i.e., vertical aperture expansion and beam scanning (represented by the set of double-headed arrows in the second section 423).

Further details of the structure and operation of optical waveguides employing differently oriented sets of partially reflective surfaces for redirecting propagating illumination from one guided direction to another guided direction and coupling the illumination out of the optical waveguide can be found in the above-mentioned U.S. Pat. No. 10,551,544.

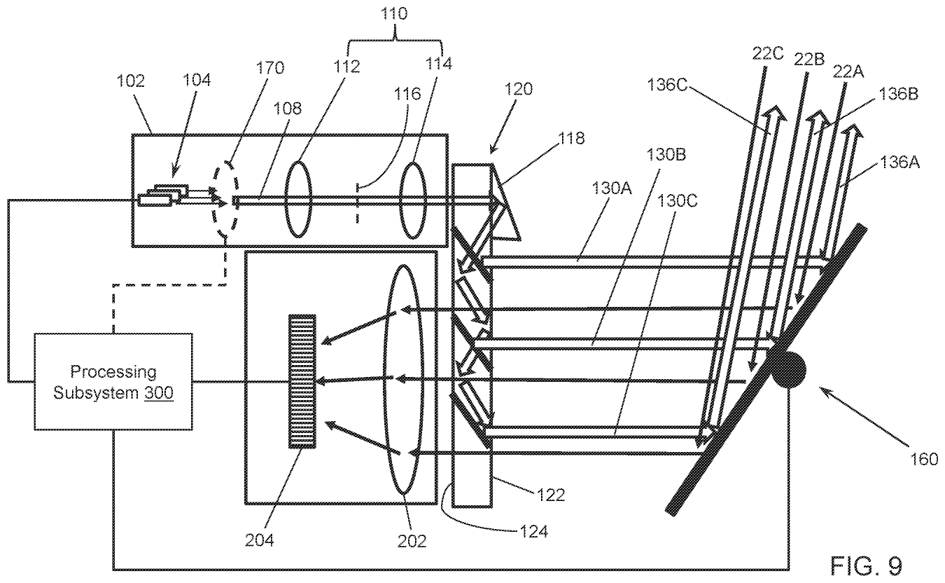

Although the embodiments of the LIDAR system described thus far have pertained to a transmitter subsystem employing a scanning arrangement as part of the illumination and beam combining unit, other embodiments are possible, in which an external scanning arrangement is deployed at the output of the optical waveguide. Referring now to FIG. 9, there is shown a. schematic representation of a system according to a non-limiting embodiment of the present invention, generally similar to the embodiment described with reference to FIG. 2, but with an external scanning arrangement 160 associated with the face 122 and deployed at the output of the optical waveguide 120 instead of the scanning arrangement 106 deployed as part of the illumination and beam combining unit 102.

In certain embodiments, the scanning arrangement 160 is configured to perform two-dimensional scanning, whereas in other embodiments the scanning arrangement 160 is configured to perform one-dimensional scanning. In embodiments in which the scanning arrangement 160 performs two-dimensional scanning, the collimating optics 110 collimate the beam 108 transmitted by the illumination arrangement 104 (optionally with pupil imaging, as indicated by the image plane 116), and the collimated beam 108 is coupled into the optical waveguide 120 for aperture multiplication via propagation by internal reflection and coupling-out by the partially reflective surfaces 126. Here, the coupled-out beams 130A, 130B, 130C illuminate a single direction, and the scanning arrangement 160 deflects the beams 130A, 130B, 130C vertically and laterally so as to perform vertical and lateral scanning, thereby two-dimensionally scanning the entire field of interest. The deflected beams that are generated by the scanning arrangement 160 from the beams 130A, 130B, 130C are represented schematically in FIG. 9 by beams 136A, 136B, 136C. Note that the lateral scanning is in and out of the plane of the paper, and therefore the lateral scanning achieved by the deflected beams 136A, 136B, 136C is, not discernible in FIG. 9.

In embodiments in which the scanning arrangement 160 performs one-dimensional scanning, for example vertical scanning, the illumination and beam combining unit 102 further includes an optical component 170 deployed at the output of the illumination arrangement 104 and upstream from the collimating optics 110, that is configured as a one-dimensional beam expander so as to generate a line of illumination in the far field and on the image plane 116. In one non-limiting implementation according to such embodiments, the optical component 170 is implemented as a one-dimensional scanning arrangement (similar to 106 in FIG. 2) that generates a line of illumination at high speed thereby generating high resolution of the scene when imaged by the detector 204. In another non-limiting implementation, the optical components 170 is implemented as a diffuser (i.e., light scattering optical element) or a cylindrical lens.

According to a non-limiting implementation according to other embodiments, the optical component 170 is implemented as a two-dimensional beam expander that illuminates a rectangular field. One example of such a two-dimensional beam expander is the optical waveguide with embedded partially reflective surfaces described with reference to FIGS. 6A and 6B. In such embodiments, the detector 204 is preferably implemented as a rectangular pixel array, so as to enable simultaneous range detection from an array of illuminated points in the field of interest. Such embodiments may not necessarily require the external scanning arrangement 160, however, the scanning arrangement 160 can be included in order to further expand the size of the scanned field in the vertical and/or lateral dimensions.

The scanning arrangement 160 can be implemented as any suitable beam diverging or beam steering mechanism, including, but not limited to, a single scanning or tilting mirror that performs scanning in two orthogonal dimensions, a pair of orthogonal single axis scanning or tilting mirrors, a set of prisms with one or more of the prisms being rotatable/tiltable about one or more axis of rotation/tilt. Preferably, the scanning arrangement 160 is electrically associated with the processing subsystem 300, which controls the scanning action of the scanning arrangement 160.

The following paragraphs describe the processing subsystem 300, and in particular the components of the processing subsystem 300 as well as the processing and control functionality provided by the processing subsystem 300. Generally speaking, the processing subsystem 300 is electrically associated with components of the transmitter 100 and the receiver 200 so as to provide both processing and control functionality to the subsystems of the LIDAR system 10. In particular, the processing subsystem 300 is electrically associated with the detector 204 and is configured to process signals from the detector 204 to derive information associated with the illuminated objects in the scene (e.g., the object 18 in FIG. 1). In certain embodiments, the derived information can be used by the processing subsystem 300 to construct a 3D representation of the object 18 and/or a mapping of the scene based on identification of wavelength-dependent changes in the signals generated by the detector 204. The processing subsystem 300 is further electrically associated with the illumination arrangement 104 and is configured to control various illumination parameters of the illumination arrangement 104, including, but not limited to, the illumination timing of the beam sources (e.g., the transmission start and stop times and the pulse duration of laser sources), modulation of the beams generated by the beam sources, and the output power of the beam sources (via amplifier control). The output power of the individual beam sources may be application specific.

The processing subsystem 300 is preferably further configured to synchronize the detector 204 with the illumination timing of the beam sources to integrate light during integration periods corresponding to the periods of illumination by the illumination arrangement 104. In addition, the processing subsystem 300 is electrically associated with the scanning arrangements of the various embodiments, e.g., the scanning arrangement 106 (FIGS. 2-4), and the external scanning arrangement 160 (FIG. 9) and/or the optical component 170 (FIG. 9) when implemented as a scanning arrangement, to control the scanning action of the scanning arrangements.

The processing system 300 may be implemented using any suitable type of processing hardware and/or software, as is known in the art, including but not limited to any combination of various dedicated computerized processors operating under any suitable operating system and implementing suitable software and/or firmware modules. The processing system 300 may further include various communications components for allowing wired or wireless communication with LAN and/or WAN devices for bidirectional transfer of information. A simplified block diagram of the processing subsystem 300 according to a non-limiting example implementation is illustrated in FIG. 10. Here, the processing subsystem 300 includes at least one computerized processor 302 coupled to a storage medium 304. The storage medium 304 can be one or more computerized memory devices, such as volatile data storage. The processor 302 (which can be more than one processor) may be implemented as any number of computerized processors including, but not limited to, microprocessors, microcontrollers, application-specific integrated circuits (ASICs), digital signal processors (DSPs), image processors, field-programmable gate arrays (FPGAs), field-programmable logic arrays (FPLAs), and the like. Such computerized processors include, or may be in electronic communication with computer readable media, which stores program code or instruction sets that, when executed by the computerized processor, cause the computerized processor to perform actions. Types of computer readable media include, but are not limited to, electronic, optical, magnetic, or other storage or transmission devices capable of providing a computerized processor with computer readable instructions.

It is noted that in addition to the processor 302 and storage medium 304, the processing subsystem 300 may include additional electronic circuitry for receiving and/or processing analog and/or digital signals, including, for example, demodulation circuitry, frequency synthesizers, frequency mixers, band-pass filters, low-pass filters, amplifiers (e.g., low-noise amplifiers), analog-to-digital converters (for example in the form of sampling and quantization circuits), digital-to-analog converters, local oscillators, and the like. It is also noted that in certain embodiments, the processing subsystem 300 itself can be integrated as part of the receiver 200. In other embodiments, subcomponents of the processing subsystem 300 can be integrated as part of the receiver 200, while other components of the processing subsystem 300 can be stand-alone components that are separate from the receiver 200,

The optical waveguide configurations and scanning arrangements of the embodiments of LIDAR systems described above with reference to FIGS. 2-9 provide various solutions for scanning a field of view of interest (i.e., a scene of interest), whereby the output beams from the LIDAR system sweep a broad number of angular positions of the field of view of interest so as to illuminate objects in the field of view. As discussed, illuminated objects in the field of view of interest reflect or backscatter some of the illumination from the LIDAR system back toward the receiver of the LIDAR system at varying corresponding directions of arrival. The detector 204 of the receiver of the LIDAR system provides photon sensing capability to enable capturing of the reflected illumination and derivation, by the processing subsystem 300, of information associated with the light-reflecting object. As discussed, the derived information is preferably used to generate 3D representations of illuminated objects in the field of view.

As is well-known to those of skill in the art, the measurement principle used for generating 3D representations of objects in LIDAR systems is time-of-flight (TOF), where the beams generated by the transmitter of the LIDAR system (e.g., transmitter 100) are projected (via beam scanning) onto an object in a scene and the reflected illumination is detected (e.g., by the detector 204) and processed (e.g., by the processing subsystem 300) to determine the distance (i.e., range) to the object allowing the creation of a 3D point cloud. The distance to the object, typically the distance from the object to the detector 204, is measured based on the round-trip delay of light waves that travel to the object. The distance measurement can be achieved by modulating the intensity, phase, and/or frequency of the transmitted laser illumination and measuring the time required for the modulation pattern to appear at the receiver.

One approach to TOF measurement is based on intensity modulation of short pulses of laser illumination. Here, short pulses of laser illumination are directed towards the scene, and the distance to the object in the scene is determined by multiplying the speed of light by the time the pulse takes to travel the distance to the object. As mentioned, the processing subsystem 300 preferably provides synchronization between the illumination arrangement 104 and the detector 204, thereby providing synchronization between pulse timing of the beam sources and integration periods of the detector 204. For TOF measurement, the processing subsystem 300 actuates a timer circuit (the timer circuit may be part of the processing subsystem 300) to initialize a timer upon transmission of each laser pulse, and actuates the timer circuit to terminate the timer upon receipt of an output signal from the detector 204. The detector 204 generates the output signal in response to capturing the illumination reflected from the object, where the output signal is indicative of the intensity of light captured by the detector 204. The TOF is measured as the elapsed time between the timer initialization and timer termination. Since the TOF is obviously representative of the twice the distance to the object (i.e., the distance from the transmitter to the object plus the distance from the object to the detector), the TOF should be halved in order to provide the actual range to the object. Therefore, using the simple intensity modulation approach, the distance to the object, D, can be expressed as:

$$D = \frac{c}{2} TOF$$

where c is the speed of light (approximated as 3×10⁸ m/s).

Another approach to TOF measurement is based on amplitude modulation of a continuous wave (referred to as AMCW), whereby the phase of the transmitted illumination is compared with the phase of the detected reflected illumination. Here, the optical power of the transmitted CW laser signal is modulated with a constant frequency f_{M}, typically a few hundred KHz, so the intensity signal of the transmitted beam is a sinusoidal or square wave of frequency f_{M}. The detector 204 captures the reflected illumination from the object and generates an output signal indicative of the intensity of the captured illumination. The distance measurement, D, is derived based on the phase shift, ΔΦ, that occurs between the transmitted intensity signal and the reflected intensity signal, as well as the modulation frequency f_{M}, and can be expressed as follows:

$$D = \frac{c}{2} \frac{Δ Φ}{2 π {f}_{M}}$$

where again, c is the speed of light.

Techniques for demodulating the generated intensity signal and extracting phase information are well-known in the art, but several brief examples are provided herein. In one non-limiting example, phase measurement can be obtained using an arrangement of mixers and low-pass filters, or by sampling the generated intensity signal and cross-correlating the sampled signal with the transmitted phase signal that is shifted by a number of fixed phase offsets. Another approach involves sampling the generated intensity signal and mixing it with the transmitted phase signal that is shifted by a number of fixed phase offsets, and then sampling the mixed signal at the resultant number of phases. The various techniques mentioned here utilize various electronic components, including, for example, mixers, filters, local oscillators, analog-to-digital converters, digital-to-analog converters, and the like, and can be implemented as electronic circuitry that can be wholly part of the receiver 200, wholly part of the processing subsystem 300, or shared between the processing subsystem 300 and the receiver 200.

Another approach to TOF measurement is based on frequency modulation of a continuous wave (referred to as FMCW), whereby the instantaneous optical frequency of the transmitted intensity signal is periodically shifted, typically by varying the output power of the beam sources. As in the AMCW approach, the detector 204 captures the reflected illumination from the object and generates an output signal indicative of the intensity of the captured illumination. However, here the signal generated by the detector 204 is mixed with the transmitted source signal to create a beat frequency that can be used to measure the object distance. For a static object, the time delay between the transmission of the laser illumination and the collection of illumination by the detector 204 causes a constant frequency difference (i.e., beat frequency) f_{B} from the mixing of the signals. By linearly varying the instantaneous optical frequency of the transmitted laser illumination over a period T, the beat frequency f_{B} varies in direct proportion to TOF, and by equivalence is therefore proportional to the distance D to the object. The proportional relationship between f_{B} and TOF can be expressed as follows:

$${f}_{B} = \frac{B}{T} TOF = \frac{B}{T} \frac{2 D}{c}$$

and therefore, D can be expressed as:

$$D = {f}_{B} \frac{c T}{2 B}$$

where B is the bandwidth of frequency sweep.

The frequency difference between the transmitted and received signal is manifested as a periodic phase difference, which causes an alternating constructive and destructive interference pattern at the beat frequency f_{B}, thereby by producing a beat signal at frequency f_{B}. The peak of the beat frequency f_{B} can be easily translated into distance by analyzing the beat signal in the frequency domain by way of Fourier analysis. One particular preferred technique for performing the frequency domain analysis is by Fast Fourier Transform (FFT). FFT algorithms are well-known in the art, and can be implemented using the processing subsystem 300.

In the example described above, the instantaneous frequency is varied linearly and monotonically increases so as to produce a ramp modulation frequency. However, in many practical applications of FMCW, a triangular modulation frequency is used instead of a ramp. Here, the rate of frequency change is expressed as 2f_{M}B, where f_{M} is the modulation frequency. Hence, the beat frequency f_{B} can be expressed as follows:

$${f}_{B} = \frac{4 {Df}_{M} B}{c}$$

Here too the beat signal can be analyzed by applying FFT algorithms to translate the peak of the beat frequency f_{B} into distance. This triangular modulation is of particular value when used to detect moving objects, where the velocity (i.e., speed and direction) of the object can be determined by calculating the Doppler frequency.

It is noted that all of the above techniques for determining TOF and distance to the object have been described within the context of pointwise measurements, in which a single pulse or single modulated beam of laser illumination is transmitted by the transmitter 100 so as to illuminate a point on an object in the scene, and whereby the receiver 200 (in particular the detector 204) captures light reflected from the object in response to the aforementioned illumination, and the processing subsystem 300 derives the TOF and distance information based on the signals generated by the detector 204 in response to capturing light. However, as is well-known in the art, one of the key outputs generated by LIDAR systems are 3D representations of the illuminated objects, which are typically in the form of 3D point clouds or 3D images rendered therefrom. Such point clouds are typically generated by scanning the field of view so as to illuminate a large number of points of the object, and responsively calculating TOF and distance from the captured backscattered (reflected) light for each illuminated point. According to preferred embodiments of the present invention, the processing subsystem 300 is configured to generate such a 3D representation, for example, a point cloud, by scanning the field of view (using the techniques enabled by the optical waveguide and scanning arrangement configurations described with reference to FIGS. 2-9) so as to illuminate multiple points on the object in the scene with beams of light. The aperture multiplied transmitted beams are repeatedly repositioned via the aforementioned scanning arrangements (or a large swath of the scene is illuminated all at once) via the aforementioned transmitter 100 configurations, and the corresponding reflected light from the object is captured by the detector 204 to generate corresponding signals, which are processed by the processing subsystem 300 according to the various techniques for determining TOF and distance described above in order to build up the point cloud. Preferably, the processing subsystem 300 provides synchronization between the illumination arrangement 104 and the various scanning arrangements (e.g., the scanning arrangements 106, 160, and the optical component 170 in certain non-limiting implementations) to enable scanned illumination of the entire field of interest.

Generally speaking, the density of the point cloud is limited by the scanning rate (i.e., how fast different regions within the scene are illuminated) and the capture rate of the detector 204. When the detector 204 is implemented as a sensor matrix or rectangular pixel array, the detector 204 can capture reflected light from multiple regions simultaneously, thereby providing a higher overall capture rate. Preferably, the transmitter 100 and the receiver 200 are configured so as to enable the processing subsystem 300 to produce a “high-density” point cloud that resembles a 3D image. The processing subsystem 300 may also be configured to convert the 3D point cloud into to a two-dimensional (2D) depth image using techniques that are well-known in the art.

Although the embodiments of the present invention described thus far have pertained to using an illumination arrangement having beam sources configured to produce light having wavelengths in the NIR region of the electromagnetic spectrum and/or the visible region of the electromagnetic spectrum, other embodiments are possible in which the illumination arrangement includes one or more beam sources configured to produce light outside of the NIR and visible regions, including, for example, beam sources configured to produce light in the ultraviolet region of the electromagnetic spectrum.

The operational range that is achievable by the system according to the embodiments described herein is typically a function of several parameters, including, for example, beam wavelength, beam intensity, pulse duration, and beam divergence. Some of these parameters may be adjusted by controlled input to the illumination arrangement 104 from the processing subsystem 300, while other parameters can be adjusted by modifying the various optical and scanning components of the illumination and beam combining unit 102, while yet other parameter can be adjusted by changing the type of beam source(s) deployed in the illumination arrangement 104. Those of ordinary skill in the art will understand how to tune the various parameters in order to achieve the desired operational range. By tuning some of these parameters, the system according to the embodiments described herein can achieve a superior operational range to conventional LIDAR system. Neglecting atmospheric attenuation, beam divergence or other degradation factors, conventional LIDAR systems that employ NIR lasers that operate at around 900 nm have a maximum operational range of approximately 100 meters. In a non-limiting example, assuming a predefined intensity (for eye-safety) at the input aperture of the optical waveguide 120, and assuming that the optical waveguide 120 provides three-fold expansion of the aperture (in two dimensions), the total output power at the output aperture of the of the transmitter 100 is increased by a factor of 9, and therefore the operational range of the system 10 is increased by a factor of 3 (in accordance with the inverse-square law) as compared to conventional LIDAR systems. Therefore, the operational range achievable by the LIDAR systems of the present invention can be expected to be at least 300 meters.

It is noted that when the LIDAR system according to embodiments of the present invention is deployed in a driver-operated ground-based vehicle or deployed for use with a driver-operated ground-based vehicle, the optical waveguides of the disclosed embodiments may be advantageously installed in front of the driver of the vehicle, for example integrated into the dashboard or front windshield of the vehicle. When the LIDAR system is deployed as part of a helmet, the optical waveguides of the disclosed embodiments may be advantageously installed as part of the helmet in a front region of the helmet.

Although the embodiments of the LIDAR system disclosed thus far have been described within the context of LIDAR applications for use with ground-based vehicles such as autonomous or semi-autonomous vehicles, the embodiments of the present invention can also be used to advantage in stationary terrestrial LIDAR applications, and airborne LIDAR applications such as remote sensing applications. For terrestrial applications, embodiments are contemplated herein in which the system is deployed on a stationary platform, such as a mount or tower, in order to collect data associated with objects in the scene. For airborne applications, embodiments are contemplated in which the system is deployed in, or mounted to, an aircraft, such as a manned (i.e., human-piloted) aircraft (e.g., an airplane, a helicopter, etc.) or an unmanned aircraft (e.g., unmanned aerial vehicle (UAV), drone, etc.). In such embodiments, the system is preferably deployed at the underside or belly of the aircraft, thereby enabling the system to collect data associated with objects in a remote scene on the ground that is monitored by aircraft (typically travelling at an altitude in the range of 10-100 meters, or up to 1 kilometer when employing high-intensity laser sources deployed on small UAVs or drones)

It is noted that although the transmitter and receiver of the embodiments disclosed thus far have been described within the specific context of use in LIDAR applications, in particular LIDAR systems deployed for use with ground-based or airborne vehicles, transmitter and receiver configurations based on the above-described embodiments may be suitable for use in non-LIDAR applications in which scene scanning is not necessary, such as in laser rangefinder applications. For example, transmitter configurations without the scanning arrangements of the above-described embodiments can be used to advantage as part of ground-mounted or hand-held laser rangefinder systems, where a single point or small cluster of points in a scene is illuminated without scanning in order to measure the distance to the point or point-cluster.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form, “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the invention.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A system comprising:
an optical waveguide having at least two major external surfaces for guiding light by internal reflection, a first of the two major external surfaces deployed in facing relation to a scene;
an optical coupling-out configuration associated with the optical waveguide configured for coupling a proportion of light, guided by the optical waveguide, out of the optical waveguide toward the scene;
an illumination arrangement deployed to emit light for coupling into the optical waveguide that is collimated prior to being coupled in the optical waveguide;
a detector for sensing light reflected from an object located in the scene in response to illumination of the object by light coupled out of the optical waveguide by the optical coupling-out configuration; and
a processing subsystem including at least one processor, the processing subsystem being electrically associated with the detector and configured to process signals from the detector to derive information associated with the object.

2. (canceled)

3. The system of claim 1, further comprising: focusing optics for focusing the reflected light onto the detector, wherein the focusing optics is associated with a second of the two major external surfaces.

4. The system of claim 1, further comprising: focusing optics for focusing the reflected light onto the detector, wherein the reflected light is transmitted by the two major external surfaces before being received by the focusing optics.

5. The system of claim 1, further comprising: focusing optics for focusing the reflected light onto the detector, wherein an output aperture of the system is defined at least in part by the coupling-out configuration, and wherein an input aperture of the system is defined at least in part by the focusing optics.

6. The system of claim 5, wherein the input aperture is at least partially overlapping with the output aperture.

7. (canceled)

8. The system of claim 1, further comprising: a diffractive optical element associated with the first of the two major external surfaces.

9. (canceled)

10. The system of claim 1, further comprising: a scanning arrangement deployed to scan the scene with light coupled out of the optical waveguide by the optical coupling-out configuration, wherein the scanning arrangement is deployed between the illumination arrangement and the optical waveguide, and wherein the scanning arrangement is configured to deflect light emitted by the illumination arrangement to cover an angular range such that the light coupled out of the optical waveguide covers a corresponding angular range.

11. The system of claim 1, further comprising: a scanning arrangement is-associated with the first of the two major external surfaces deployed to scan the scene with light coupled out of the optical waveguide by the optical coupling-out configuration.

12. The system of claim 1, further comprising: collimating optics deployed in an optical path between the illumination arrangement and the optical waveguide for collimating light emitted by the illumination arrangement prior to coupling into the optical waveguide.

13. The system of claim 1, further comprising: an optical component deployed in an optical path between the illumination arrangement and the optical waveguide and configured to perform aperture expansion of light emitted by the illumination arrangement in at least a first dimension.

14. The system of claim 13, further comprising: a scanning arrangement associated with the first of the two major external surfaces and configured to scan a second dimension orthogonal to the first dimension.

15. The system of claim 13, wherein the optical component is configured to perform expansion of light emitted by the illumination arrangement in the first dimension and in a second dimension orthogonal to the first dimension.

16. The system of claim 13, wherein the optical component includes: a light-transmitting substrate for guiding light emitted by the illumination arrangement by internal reflection, and a second optical coupling-out configuration associated with the substrate for coupling a proportion of light, guided by the substrate, out of the substrate toward the optical waveguide.

17. The system of claim 1, wherein the optical coupling-out configuration is selected from the group consisting of: a plurality of partially reflective surfaces deployed within the optical waveguide obliquely to the two major external surfaces, and a diffractive optical element associated with at least one of the two major external surfaces.

18. (canceled)

19. The system of claim 1, further comprising: an optical coupling-in configuration associated with the optical waveguide and configured for coupling light into the optical waveguide so as to propagate within the optical waveguide by internal reflection.

20-31. (canceled)

32. The system of claim 1, wherein the optical waveguide has a trapezoidal-shape in a cross-sectional plane so as to effect lateral scanning of the scene with light coupled out of the optical waveguide.

33. The system of claim 32, further comprising:
a light-transmitting substrate having two pairs of parallel major external surfaces forming a rectangular cross-section; and
an optical coupling configuration associated with the substrate, wherein light that is coupled into the substrate advances by four-fold internal reflection through the substrate and a proportion of intensity of the light advancing through the substrate is coupled out of the substrate by the optical coupling configuration and into the optical waveguide.

34. The system of claim 1, wherein the optical waveguide includes two pairs of parallel major external surfaces forming a rectangular cross-section, and wherein light that is coupled into the optical waveguide advances by four-fold internal reflection through the optical waveguide.

35. The system of claim 1, further comprising: an optical coupling configuration, and wherein the optical waveguide includes a first waveguide section associated with the optical coupling configuration and a second optical waveguide section associated with the optical coupling-out configuration, and wherein light that is coupled into the optical waveguide advances through the first waveguide section by internal reflection and a proportion of intensity of the light advancing through the first waveguide section is deflected in a first direction by the optical coupling configuration so as to be coupled out of the first waveguide section and into the second waveguide section so as to advance through the second waveguide section by internal reflection, and wherein light advancing through the second waveguide section is deflected in a second direction by the optical coupling-out configuration so as to be coupled out of the optical waveguide toward the scene.

36. The system of claim 35, wherein the optical coupling configuration effectuates scanning of light in a first dimension, and wherein the optical coupling-out configuration effectuates scanning of light in a second dimension substantially orthogonal to the first dimension.

37. A light detection and ranging (LIDAR) system comprising:
a transmitter comprising:
an optical waveguide having at least two major external surfaces for guiding light by internal reflection, one of the major external surfaces deployed in facing relation to a scene,
an optical coupling-out configuration associated with the optical waveguide configured for coupling a proportion of light, guided by the optical waveguide, out of the optical waveguide toward the scene,
at least one beam source configured to emit a coherent beam of light for coupling into the optical waveguide that is collimated prior to being coupled in the optical waveguide, and
a scanning arrangement deployed to scan the scene with light coupled out of the optical waveguide by the optical coupling-out configuration;
a receiver comprising:
a detector for sensing light reflected from an object located in the scene in response to illumination of the object by light coupled out of the optical waveguide by the optical coupling-out configuration; and
a processing subsystem including at least one processor, the processing subsystem being electrically associated with the detector and configured to process signals from the detector to construct a three-dimensional representation of the object.

38-40. (canceled)
